(19) United States
(12) Patent Application Publication
(10) Pub. No.: US 2011/0311242 A1
(43) Pub. Date: Dec. 22, 2011

(54) TONER CARTRIDGE THAT CONTRACTS ACCORDING TO TONER SUPPLY

(75) Inventor: Tsukasa Tanda, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/159,629

(22) Filed: Jun. 14, 2011

Related U.S. Application Data
(60) Provisional application No. 61/356,886, filed on Jun. 21, 2010.

(51) Int. Cl. G03G 15/08

(52) U.S. Cl. 399/27; 399/262; 399/258

(57) ABSTRACT

A toner cartridge includes an accordion container that stores a toner and contracts in a housing of an image forming apparatus according to a development process.

### CROSS-REFERENCE TO RELATED APPLICATION

This application is based upon and claims the benefit of priority from Provisional U.S. Application 61/356,886 filed on Jun. 21, 2010, the entire contents of which are incorporated herein by reference.

### FIELD

Embodiments described herein relate generally to a toner cartridge that supplies a toner to a developing device of a copying machine, a printer, or the like.

### BACKGROUND

As a developing device of a magnetic brush type used for development in a multi function peripheral (abbreviated as MFP), a printer, or the like, there is a device in which a toner cartridge is inserted into a housing to supply a toner. The toner cartridge is increased in size in order to store a large amount of toner. Therefore, it is likely that the size of a space for storing a used toner cartridge in an office or the like until the used toner cartridge is collected increases. It is also likely that a toner residual amount in a toner cartridge is not displayed to a user until the toner is nearly exhausted.

Therefore, there is a demand for development of a toner cartridge that realizes a reduction in the space for storing the used toner cartridge and makes it easy to know a replacement period.

### BRIEF DESCRIPTION OF THE DRAWINGS

FIG. 1 is a schematic diagram of a main part of a printer and a control block schematic diagram of components around a toner cartridge of an embodiment;

FIG. 2 is a schematic explanatory diagram of a toner cartridge set in a housing viewed from a side of the housing of the embodiment;

FIG. 3 is a schematic explanatory diagram of the toner cartridge set in the housing viewed from the front of the housing of the embodiment;

FIG. 4 is a schematic explanatory diagram of the toner cartridge during supply of a toner to a developing device viewed from the side of the housing of the embodiment;

FIG. 5 is a schematic explanatory diagram of the toner cartridge during supply of the toner to the developing device viewed from the front of the housing of the embodiment;

FIG. 6 is a schematic explanatory diagram of the empty toner cartridge viewed from the side of the housing of the embodiment;

FIG. 7 is a schematic explanatory diagram of the empty toner cartridge viewed from the front of the housing of the embodiment;

FIG. 8 is a schematic perspective view of a main part of the housing of the embodiment;

FIG. 9 is a schematic explanatory diagram of a state in which a shaft screw of a pressing machine is out of a ring gear of the embodiment;

FIG. 10 is a schematic explanatory diagram of a state in which the shaft screw of the pressing machine fits in the ring gear of the embodiment; and

FIG. 11 is a schematic explanatory diagram of another example of an accordion container of the embodiment.

### DETAILED DESCRIPTION

According to an embodiment, a toner cartridge includes an accordion container that stores a toner and contracts in a housing of an image forming apparatus according to a development process.

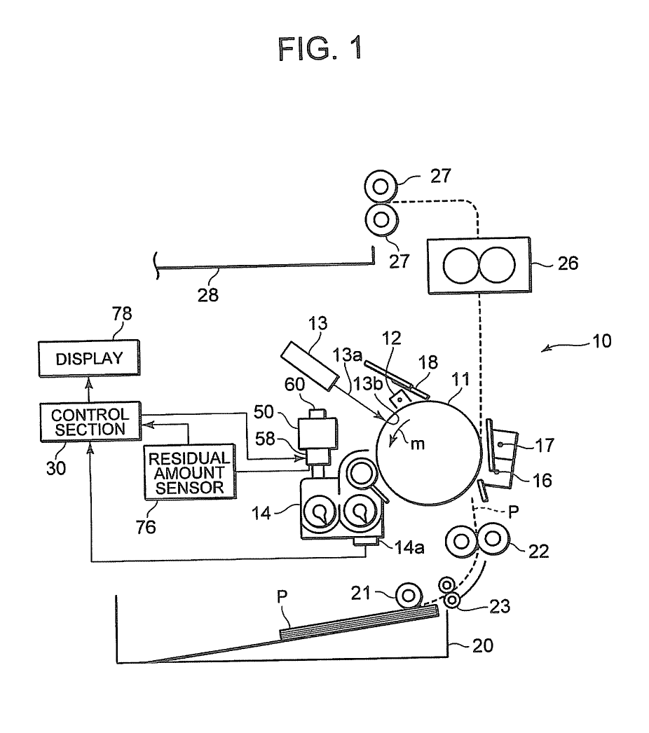

An embodiment is explained below. FIG. 1 shows a main part of a printer 10 as an image forming apparatus of the embodiment. The printer 10 includes a charger 12, an exposing device 13, a developing device 14, a transfer charger 16, a peeling charger 17, and a cleaner 18 around a photoconductive drum 11 as an image bearing member, rotating in an arrow m direction. The charger 12 and the exposing device 13 configure a latent-image forming section. The printer 10 includes a toner cartridge 50 that supplies a toner to the developing device 14.

The developing device 14 is a developing device of a magnetic brush type that performs development using a two-component developer including a toner and a carrier. The developing device 14 includes a density sensor 14a that detects toner density of the two-component developer. The density sensor 14a inputs a detection result to a control section 30 configured to control the entire printer 10. The printer 10 includes a toner supply device 58 on the rear side of a housing 10a of the printer 10. The toner supply device 58 supplies the toner in the toner cartridge 50 to the developing device 14 according to the toner density of the developing device 14. The printer 10 further includes a pressing machine 60 on the rear side of the housing 10a of the printer 10. The pressing machine contracts the toner cartridge 50 according to a development process of the developing device 14.

The charger 12 uniformly charges the photoconductive drum 11 according to the start of print. The exposing device 13 irradiates a laser beam 13a on an exposing position 13b of the uniformly-charged photoconductive drum 11 on the basis of image data or the like and forms an electrostatic latent image on the photoconductive drum 11. The developing device 14 applies the toner to the electrostatic latent image on the photoconductive drum 11 and visualizes the electrostatic latent image.

The transfer charger 16 transfers a toner image formed on the photoconductive drum 11 onto a sheet P as a recording medium. The peeling charger 17 peels the sheet P, onto which the toner image is transferred, off the photoconductive drum 11. The cleaner 18 cleans the toner remaining on the photoconductive drum 11 after the transfer. The sheet P is picked up from a paper feeding cassette 20 by a pickup roller 21. The sheet P picked up from the paper feeding cassette 20 is conveyed to a separation roller 23 and a registration roller 22 and reaches the transfer charger 16 in synchronization with the toner image formed on the photoconductive drum 11.

The printer 10 transfers, with the transfer charger 16, the toner image formed on the photoconductive drum 11 onto the sheet P. After the transfer the printer 10 peels, with the peeling charger 17, the sheet P off the photoconductive drum 11. The printer 10 includes, further downstream than the peeling charger 17 in a conveying direction of the sheet P, a fixing device 26 and a paper discharge roller 27 configured to discharge the sheet P after fixing to a paper discharge section 28. The printer 10 fixes, with the fixing device 26, the toner image on the sheet P and discharges, with the paper discharge roller 27, the sheet P to the paper discharge section 28.

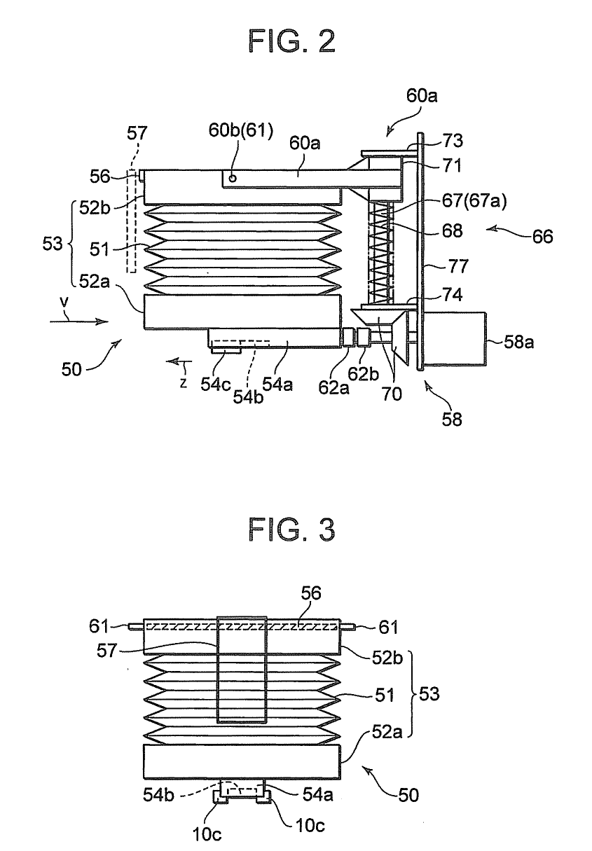

The toner cartridge 50 and the operation of the toner cartridge 50 are explained in detail below. As shown in FIGS. 2 to 7, the toner cartridge 50 includes an accordion section 51 that contracts and an accordion container 53 including a lower holder 52a and an upper holder 52b that support both sides of the accordion section 51. The toner cartridge 50 includes a toner carrying section 54a, a toner supply port 54b and a sliding cover 54c in the lower holder 52a. The toner cartridge 50 includes, on a side surface of the upper holder 52b, an indicator line 56 as an indicator that displays a residual amount of the toner in the toner cartridge 50.

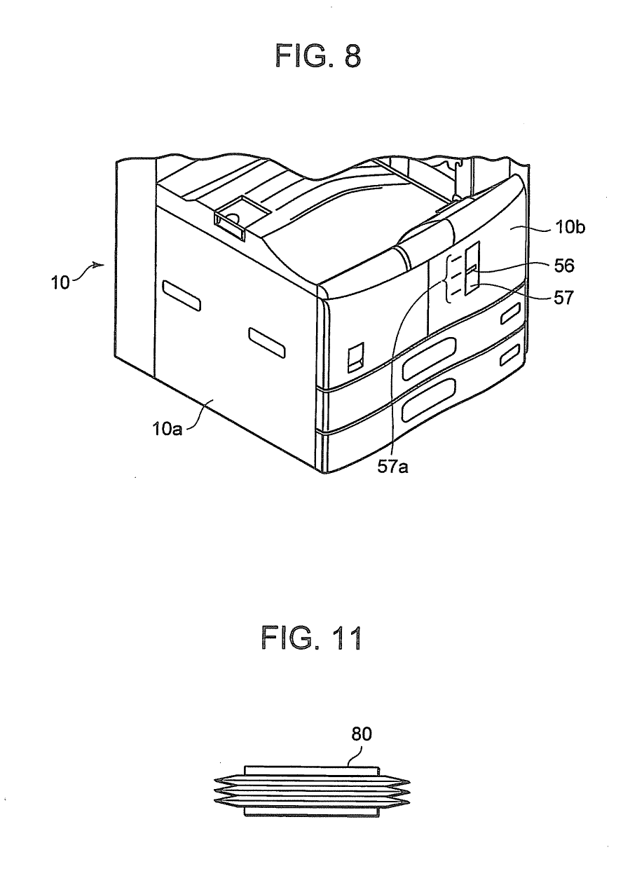

The indicator line 56 is located in a position opposed to a display window 57 formed on a front cover 10b of the housing 10a shown in FIG. 8. A user views the height of the indicator line 56 seen from the display window 57 and checks a residual amount of the toner in the toner cartridge 50. The front cover 10b includes, on a side of the display window 57, a scale 57a that indicates the position of the indicator line 56.

If the toner cartridge 50 is inserted into the housing 10a, the toner carrying section 54a fits in a guide rail 10c and guide pins 61 fit in pin supporting sections 60b of a slide arm 60a of the pressing machine 60.

The toner supplying device 58 includes a toner supply motor 58a. The control section 30 instructs driving of the toner supply motor 58a according to a detection result of the density sensor 14a. If the cartridge 50 is present in a toner supply position in the housing 10a, a driving receiving section 62a of the toner carrying section 54a and a driving end 62b of the toner supply device 58 are coupled. The driving of the toner supply motor 58a is transmitted to the toner carrying section 54a by the coupling of the driving receiving section 62a and the driving end 62b.

If the toner density in the developing device 14 reduces, the toner supply motor 58a is driven by a predetermined amount according to an instruction of the control section 30. The toner supply motor 58a supplies a predetermined amount of the toner from the toner cartridge 50 to the developing device 14. The toner density in the developing device 14 is maintained constant by the toner supply from the toner cartridge 50.

The toner supply device 58 includes a residual amount sensor 76 that detects a toner residual amount of the toner cartridge 50, for example, according to the number of revolutions of the toner supply motor 58a. The residual amount sensor 76 inputs a detection result to the control section 30. The control section 30 displays “toner empty” of the toner cartridge 50 on a display 78 of the housing 10a according to the detection result of the residual amount sensor 76.

The pressing machine 60 presses, with an arm slide guide 66, the upper holder 52b via the slide arm 60a. The arm slide guide 66 includes a rotating shaft 67 supported by an upper supporting plate 73 of a stay 77 and a return spring 68. A gear section 70 transmits the driving of the toner supply motor 58a to the rotating shaft 67. If driven, the toner supply motor 58a rotates the toner carrying section 54a of the toner cartridge 50 and the rotating shaft 67.

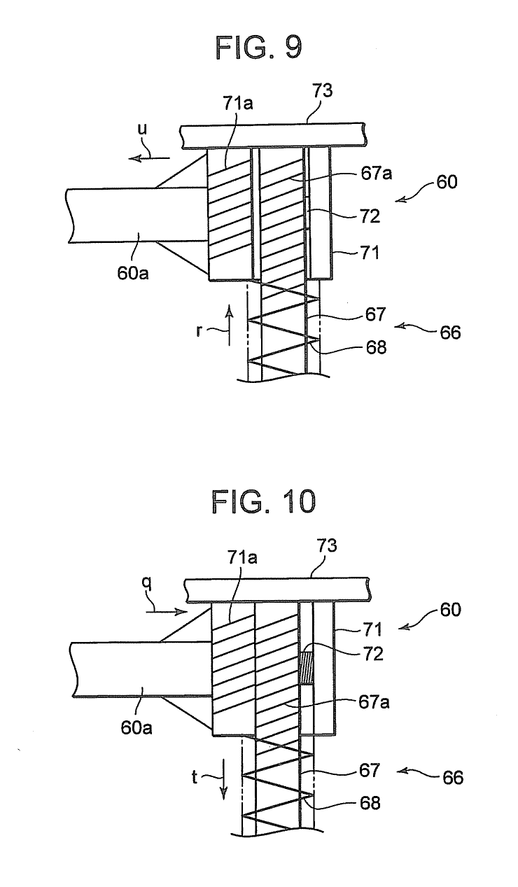

As shown in FIGS. 9 and 10, a surface of the rotating shaft 67 includes a shaft screw 67. The slide arm 60a includes a slide ring 71 that the rotating shaft 67 is inserted. The slide ring 71 includes a ring gear 71a on the inner surface. The slide ring 71 thereof, that fits with the shaft screw 67a.

The slide ring 71 includes a ring spring 72 that applies spring force in an n direction to the ring gear 71a and separates the ring gear 71a from the shaft screw 67a. If the toner cartridge 50 is inserted into the housing 10a, the toner cartridge 50 presses the slide arm 60a in an arrow q direction against the spring force of the ring spring 72. If the slide arm 60a is moved in the arrow q direction, the ring gear 71a fits in the shaft screw 67a. The return spring 68 is supported by a lower supporting plate 74 that guides the rotating shaft 67 and applies spring force in an arrow r direction to the slide ring 71. The slide ring 71 stops in an initial position where the slide ring 71 contacts with the upper supporting plate 73 and come to a standstill.

Before a new toner cartridge 50 in which the toner is filled and the accordion section 51 of the accordion container 53 is expanded is inserted into the housing 10a of the printer 10, the slide arm 60a is present in an initial position where the slide ring 71 comes into contact with the upper supporting plate 73. The slide ring 71 is present in a position where, as shown in FIG. 9, the ring gear 71a is separated from the shaft screw 67a by spring force of the ring spring 72 acting in the arrow n direction.

In order to insert the new toner cartridge 50 into the housing 10a, the toner carrying section 54a is fit in the guide rail 10c of the housing 10a from the front side of the housing 10a and the toner cartridge 50 is slid in an arrow v direction from the front side. The toner cartridge 50 is present in the toner supply position in the housing 10a, the driving receiving section 62a of the toner carrying section 54a and the driving end 62b of the toner supply device 58 are coupled, and the guide pins 61 of the toner cartridge 50 fit in the pin supporting sections 60b of the slide arm 60a present in the initial position. If the driving receiving section 62a of the toner cartridge 50 and the driving end 62b of the toner supply device 58 are coupling, the cover 54c slides in an allow z direction to open the toner supply port 54b.

If the driving receiving section 62a and the driving end 62b are coupled, the slide ring 71 is slid in the arrow q direction by the toner cartridge 50 via the slide arm 60a. As shown in FIG. 10, the ring gear 71a fits in the shaft screw 67a. In the initial time, the indicator line 56 included in the upper holder 52b is located at the top of the display window 57, for example, as shown in FIG. 3. The user views the indicator line 56 in the display window 57 and confirms that the toner cartridge 50 is full.

If the toner density of the developing device 14 reduces while print is performed, the control section 30 drives the toner supply motor 58a in order to supply the toner to the developing device 14. According to the driving of the toner supply motor 58a, the toner carrying section 54a carries the toner in the toner cartridge 50 to the toner supply port 54b and supplies the toner to the developing device 14. The rotating shaft 67 of the arm slide guide 66 rotates according to the driving of the toner supply motor 58a.

If the rotating shaft 67 rotates, the slide ring 71 having the ring gear 71a that fits in the shaft screw 67a of the rotating shaft 67 is guided by the shaft screw 67a and slides in an arrow t direction against the return spring 68. According to the slide in the arrow t direction of the slide ring 71, the slide arm 60a presses the upper holder 52b of the accordion container 53 in the arrow t direction. The accordion section 51 of the accordion container 53 gradually contracts while being pressed by the slide arm 60a.

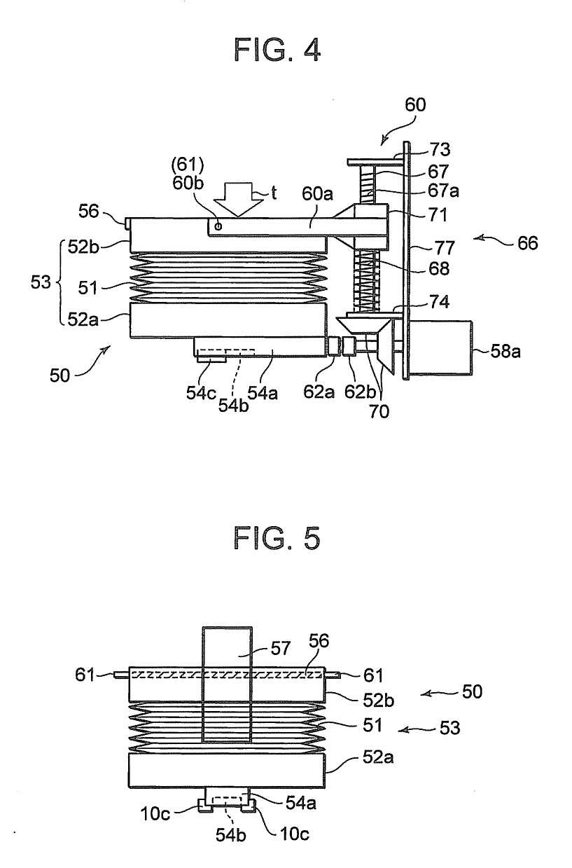

If the toner supplies from the toner cartridge 50 proceeds, the upper holder 52b is pressed, and, for example, the accordion section 51 contracts to a position shown in FIG. 4, as shown in FIG. 5, the indicator line 56 is located in the middle of the display window 57. The user views the indicator line 56 in the display window 57 and confirms, according to the scale 57a of the front cover 10b, that a toner residual amount of the toner cartridge 50 is about a half.

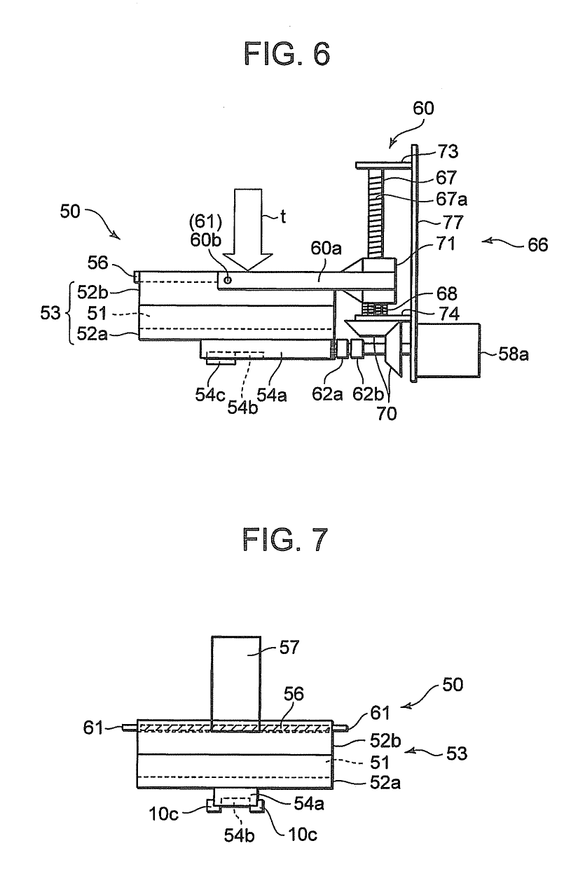

If the toner cartridge 50 is emptied, the accordion container 53 is pressed by the slide arm 60a and, for example, as shown in FIG. 6, the upper holder 52b comes into contact with the lower holder 52a. If the toner cartridge 50 is empty, the accordion section 51 of the accordion container 53 is contained in the lower holder 52a and the upper holder 52b. If the toner cartridge 50 is emptied, as shown in FIG. 7, the indicator line 56 is located at the bottom of the display window 57. The user views the indicator line 56 in the display window 57 and confirms that the toner cartridge 50 is empty.

For example, timing that the user views the indicator line 56 in the display window 57 and confirms that the toner cartridge 50 is empty and timing that “toner empty” is displayed on the display 78 are set substantially the same. However, before “toner empty” is displayed on the display 78, the user can predict a replacement period of the toner cartridge 50 by viewing the indicator line 56 in the display window 57.

If “toner empty” is displayed on the display 78, the user replaces the used toner cartridge 50 with the new toner cartridge 50. During “toner empty” display, the toner cartridge 50 is empty and the accordion section 51 of the accordion container 53 contracts and is contained in the lower holder 52a and the upper holder 52b. The toner cartridge 50 is reduced in size to a shape shown in FIGS. 6 and 7. The user removes the reduced used toner cartridge 50 from the housing 10a and temporarily stores the used toner cartridge 50, for example, in an office until the used toner cartridge 50 is collected. The shape of the accordion container may be any shape as long as the accordion section contracts and the toner cartridge is reduced in size if the toner cartridge is emptied. For example, the accordion container may be an accordion container 80 shown in FIG. 11.

If the reduced used toner cartridge 50 is removed from the housing 10a, the slide ring 71 slides in the arrow n direction with the spring force of the ring spring 72. If the slide ring 71 slides in the arrow n direction, the ring gear 71a separates from the shaft screw 67a. The slide ring 71 is freed from the shaft screw 67a and slide in the arrow r direction along the rotating shaft 67 with the spring force of the return spring 68. If the slide ring 71 contacts with the upper supporting plate 73 and stops, the slide arm 60a returns to the initial position together with the slide ring 71.

The user slides the new cartridge 50, in which the toner is filled, along the guide rail 10c, fits the guide pins 61 of the toner cartridge 50 in the pin supporting sections 60b of the slide arm 60a present in the initial position, and sets the new toner cartridge 50 in the housing 10a.

A toner cartridge may be a type in which a toner can be supplied by expanding and contracting an accordion container in a housing instead of a type in which the toner cartridge is replaced every time the toner cartridge is emptied. However, if the toner cartridge is replaced, the toner cartridge is collected in a state in which an accordion section is contracted and the accordion container is reduced in size.

According to the embodiment, the accordion container 53 of the toner cartridge 50 is formed by the accordion section 51 and the lower holder 52a and the upper holder 52b configured to support the accordion section 51. According to toner supply to the developing device 14, the upper holder 52b is pushed down by the pressing machine 60 to contract the accordion section 51. If the toner cartridge 50 is emptied, the accordion section 51 is contained in the lower holder 52a and the upper holder 52b to reduce the used toner cartridge 50 in size. A storage space for the used toner cartridge 50 is reduced in size. The user views the indicator line 56 provided in the upper holder 52b from the display window 57 of the front cover 10b and checks a toner residual amount in the accordion container 53. Before “toner empty” is displayed on the display 78, the user can view the indicator line 56, predict replacement of the toner cartridge 50, and prepare a new toner cartridge earlier.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A toner cartridge comprising:
an accordion container that stores a toner and contracts in a housing of an image forming apparatus according to a development process.

2. The toner cartridge according to claim 1, wherein the accordion container includes an accordion section which is contracted and a holder that contains the accordion section if the toner in the accordion container is empty.

3. The toner cartridge according to claim 1, further comprising an indicator that displays a residual amount of the toner in the accordion container in association with the contraction of the accordion container.

4. The toner cartridge according to claim 3, wherein the indicator is an indicator line formed on a side surface of the accordion container to be opposed to a display window of the housing.

5. The toner cartridge according to claim 1, wherein the accordion container expands in the housing after the toner in the accordion container is empty.

6. The toner cartridge according to claim 2, wherein the accordion container is removed from the housing in a state in which the holder contains the accordion section.

7. An image forming apparatus comprising:
a developing device that develops an electrostatic latent image formed on an image bearing member; and
a pressing machine that compresses an accordion section of a toner cartridge which stores a toner, according to a development process of the developing device.

8. The apparatus according to claim 7, further comprising a display window which provided on a cover of a housing and that displays an indicator associated with contraction of the accordion section.

9. The apparatus according to claim 7, wherein the pressing machine is able to compress the accordion section if the toner cartridge is set in a housing and the pressing machine returns to an initial position if the toner cartridge is drawn out from the housing.

10. The apparatus according to claim 7, further comprising a toner supply device that supplies the toner to the developing device and the pressing machine is driven using driving of the toner supply device.

11. The apparatus according to claim 7, further comprising a detecting section that detects the development process and detect that the toner cartridge is empty, and timing that the pressing machine completes the compression of the accordion section coincides with timing that the detecting section detects that the toner cartridge is empty.

12. A supply method of a developer comprising:
setting a toner cartridge including an accordion section in a housing; and
compressing the toner cartridge according to a development process.

13. The method according to claim 12, further comprising drawing out the compressed toner cartridge from the housing.

14. The method according to claim 12, further comprising displaying the compression of the toner cartridge on a display window of the housing.
